(19) United States
(12) Patent Application Publication
(10) Pub. No.: US 2016/0304683 A1
(43) Pub. Date: Oct. 20, 2016

(54) MOULDINGS BASED ON DIENE-FUNCTIONALIZED (METH)ACRYLATES AND (HETERO-)DIELS-ALDER DIENOPHILES, WITH REVERSIBLE CROSSLINKING

(71) Applicants: Friedrich Georg SCHMIDT, Haltern am See (DE); Stefan Hilf, Singapore (SG); Michael Kube, Haltern am See (DE); Zuhal Tuncay, Herne (DE)

(72) Inventors: Friedrich Georg SCHMIDT, Haltern am See (DE); Stefan Hilf, Singapore (SG); Michael Kube, Haltern am See (DE); Zuhal Tuncay, Herne (DE)

(73) Assignee: EVONIK DEGUSSA GmbH, Essen (DE)

(21) Appl. No.: 15/037,833

(22) PCT Filed: Nov. 6, 2014
(86) PCT No.: PCT/EP2014/073918

§ 371 Date: May 19, 2016

(30) Foreign Application Priority Data
Nov. 19, 2013 (DE) 10 2013 223 544.5

(51) Int. Cl. C08J 5/24; B29B 13/08; B29C 35/02; B29C 35/16; B29C 70/48; B29B 15/10; B29B 13/02

(52) U.S. Cl. CPC C08J 5/24; B29B 15/10; B29B 13/08; B29B 13/02; B29C 35/16; B29C 70/48; B29C 35/02; C08J 2333/12; B29K 2033/08

(57) ABSTRACT

The invention relates to a method for the production of storage-stable prepregs and moulded objects produced therefrom (composite components). The composition used according to the invention for the production of the prepregs here contains A) monomers, in particular (meth)acrylates and/or styrene, B) at least one (meth)acrylate with a residue which contains a conjugated diene, C) a crosslinker having at least two dienophilic groups, and D) at least one suitable initiator.

Alternatively, instead of or additionally to the components B) and C), the composition can contain a product C′ of a Diels-Alder reaction of the two components B) and C).

### FIELD OF THE INVENTION

The invention relates to a method for the production of storage-stable prepregs and moulded objects produced therefrom (composite components).

Fibre-reinforced materials in the form of prepregs are already used in many industrial applications because of their ease of handling and the increased efficiency during processing in comparison to the alternative wet-layup technology.

Industrial users of such systems, in addition to faster cycle times and higher storage stability—even at room temperature—also demand the option of cutting the prepregs to size, without the cutting tools becoming contaminated with the often sticky matrix material during automated cutting and lay-up of the individual prepreg layers. Various moulding processes, such as for example the reaction transfer moulding (RTM) process, comprise the introduction of the reinforcing fibres into a mould, closing of the mould, introduction of the crosslinkable resin fomiulation into the mould, and subsequent crosslinking of the resin, typically by application of heat.

One of the limitations of such a process is the relatively difficult laying of the reinforcing fibres into the mould. The individual layers of the woven or nonwoven fabric must be cut to size and matched to the different mould geometries. This can be both time-intensive and complicated, in particular when the moulded objects are also intended to contain foam or other cores. Mouldable fibre reinforcements with simple handling and existing moulding possibilities would be desirable here.

### PRIOR ART

As well as polyesters, vinyl esters and epoxy systems there are a number of specialized resins in the crosslinking resin matrix systems field. These also include polyurethane resins which because of their toughness, damage tolerance and strength are used in particular for the production of composite profiles, e.g. via pultrusion processes. As a disadvantage, the toxicity of the isocyanates used is often mentioned. However the toxicity of epoxy systems and the curing components used there should also be regarded as critical. This applies especially for known sensitizations and allergies.

Prepregs and composites produced therefrom on the basis of epoxy systems are for example described in WO 98/50211, EP 309 221, EP 297 674, WO 89/04335 and U.S. Pat. No. 4,377,657. In WO 2006/043019, a method for the production of prepregs on the basis of epoxide resin-polyurethane powders is described. Furthermore, prepregs based on thermoplastics in powder form as a matrix are known.

In WO 99/64216, prepregs and composites and a method for their production are described, in which emulsions with polymer particles so small as to enable single fibre coating are used. The polymers of the particles have a viscosity of at least 5000 centipoise and are either thermoplastics or crosslinking polyurethane polymers.

In EP 0590702, powder impregnations for the production of prepregs are described, wherein the powder consists of a mixture of a thermoplastic and a reactive monomer or prepolymer. WO 2005/091715 also describes the use of thermoplastics for the production of prepregs.

Prepregs with a matrix based on 2-component polyurethanes (2-C PUR) are likewise known. The 2-C PUR category essentially comprises the classical reactive polyurethane resin systems. In principle this is a system consisting of two separate components, While the critical component of one component is always a polyisocyanate, such as for example polymeric methylenediphenyl diisocyanate (MDI), the second component consists of polyols or in more recent developments also amino or amine-polyol mixtures. The two parts are only mixed together shortly before processing. After this, the chemical curing takes place by polyaddition with formation of a network of polyurethane or polyurea, After the mixing of the two components, 2-component systems have a limited processing period (moulding time, pot life), since the commencing reaction leads to a gradual increase in viscosity and finally to the gelling of the system. However, many variables determine its effective processability period: Reactivity of the reaction partners, catalysis, concentration, solubility, moisture content. NCO/OH ratio and ambient temperature are the most important [see: Coating Resins, Stoye/Freitag, Hauser-Verlag 1996, pages 210/212]. The disadvantage of the prepregs based on such 2-C PUR systems is that only a short period is available for the processing of the prepreg to a composite. Consequently such prepregs are not storage stable over several hours, let alone days.

Apart from the different binder basis, moisture-curina coatings largely correspond to analogous 2C systems both in their composition and also in their properties, In principle, the same solvents, pigments, fillers and additives are used. Unlike 2C coatings, for stability reasons these systems tolerate no moisture whatever before their application.

In DE 102009001793.3 and DE 102009001806.9, a method is described for the production of storage-stable prepregs, essentially made up of A) at least one fibrous support and B) at least one reactive polyurethane composition in powder form as matrix material.

The systems here can also contain poly(meth)acrylates as co-binder or polyol component. In DE 102010029355.5, such compositions are introduced into the fibre material by a direct melt impregnation process. In DE 102010030234.1, by a pretreatment with solvents, A disadvantage of these systems is the high melt viscosity or the use of solvents which must in the meantime be removed, or can also entail disadvantages from the toxicological viewpoint

### OBJECT

Against the background of the prior art, the object of the present invention was to provide a novel prepreg technology which enables a simpler process for the production of prepreg systems which can be handled without problems.

In particular it was an object of the present invention to provide an accelerated process for the production of prepregs which enables markedly extended storage stability and/or processing period (moulding time, pot life) compared to the prior art. Further, the weight loss, in particular in the form of evaporation of the reactive diluent, should be maintained at less than 20%, based on the matrix.

At the same time, the fibre impregnation should be simplified, Furthermore, the compositions to be used in the process should be suitable not only for melt or powder impregnation processes for the production of prepregs, but also for RTM processes.

### ACHIEVEMENT OF OBJECT

The objects are achieved by means of a novel composition and a novel process for curing this composition. According to the invention, this composition is preferably used as resin for the production of prepregs, These prepregs are then suitable for further processing into moulded parts. The composition according to the invention contains at least the components A to D. Here component A is a (meth)acrylate with an alkyl residue with 1 to 10 carbon atoms, styrene or a mixture of such (meth)acrylates and/or styrene. Preferred examples of such monomers in the mixture of component A are methyl methacrylate, butyl (meth)acrylate and styrene. Here the term (meth)acrylate stands for corresponding methacrylates and/or acrylates. In addition to component A, the composition can contain further non-crosslinkable monomers copolymerizable with the monomers of component A such as for example a-olefins, cyclic olefins, (meth)acrylic acid, maleic acid or itaconic acid, In particular, the formulation can optionally and at the same time preferably contain functionalized (meth)acrylates as component A′. Preferably these functionalized (meth)acrylates are monomers which have adhesion-promoting properties towards the fibre material used. Thus for carbon fibres, glycidyi (meth)acrylates can very preferably be added as component A′. In particular, the composition of the monomers in terms of content and composition is advantageously selected with reference to the desired technical function and the support material to be crosslinked.

Component B is a (rneth acrylate with a residue which contains a conjugated diene. Component B can also be a mixture of various such monomers. Component B is preferably one or more compounds of the following formulae:

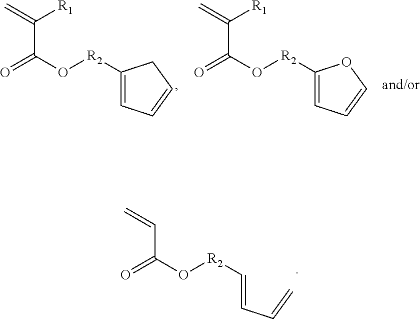

Here R₁ is preferably hydrogen or a methyl group and R₂ a divalent alkyl group with preferably 1 to 4 carbon atoms.

Component C is a crosslinker which contains at least two dienophilic groups. Component C is preferably a dienophile with at least two carbon-sulphur double bonds. Particularly preferably, component C has the following structure:

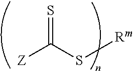

Here Z is an electron-withdrawing group, such as for example a cyano group or a pyridine ring in the α position, R^{m} is a polyvalent organic group or a polymer and n is a number between 2 and 20.

Two examples of such crosslinkers having two dienophilic groups are the following compounds:

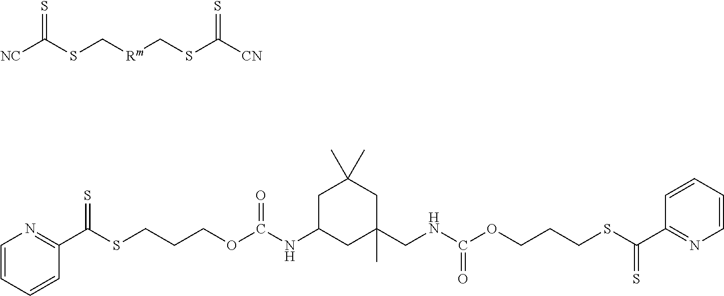

The description of suitable crosslinkers with dienophilic groups and diene functionalities suitable for this can for example be found in WO 2011/101176.

An alternative, but equally preferred embodiment of the invention is characterized in that alternatively or additionally to the components B and C the product C′ of a Diels-Alder reaction of these two components B and C is added to the composition.

Concerning this alternative embodiment, there are two especially preferred modifications. In the first of these modifications, compound C′ is a compound with the structure

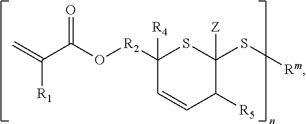

wherein R₁ is hydrogen or a methyl group. R₂ is a divalent alkyl group with 1 to 4 carbon atoms. Z is an electron-withdrawing aroup. R^{m} is a polyvalent organic group or a polymer, n is a number between 2 and 20, R₅ is an alkyl or aryl group and R₄ is hydrogen or the residues R₄ and R₅ are a shared bridging oxygen atom or a shared bridging methylidene group.

In an alternative preferred embodiment as regards component C′, component C′ is a compound which is obtained by means of a Dieis-Alder reaction from a dienophile with the structure

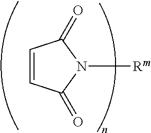

and a diene described above. Here R^{m} is a polyvalent organic group or a polymer and n a number between 2 and 20.

In a particularly preferred embodiment of this second modification, compound C′ is a compound with the structure

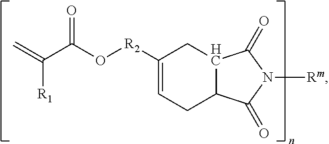

wherein R₁ is hydrogen or a methyl group. R₂ is a divalent alkyl group with 1 to 4 carbon atoms. Z is an electron-withdrawing group, R^{m} is a polyvalent organic group or a polymer and n is a number between 2 and 20.

It is decisive for the present invention that the monomers and optionally the prepolymers have functional groups. Such functional groups are the dienes which react with the dienophiles from the crosslinker component with addition and thus crosslink reversibly.

Component D is a thermally activatable initiator, a decomposition catalyst, a combination of an initiator and an accelerator and/or a photoinitiator.

As thermally activatable initiators, peroxides or aza initiators above all have long been known to those skilled in the art. The accelerators that can optionally be added for lowering the initiation temperature are normally tertiary, mostly aromatic amines.

Possible decomposition catalysts are metal complexes which decompose an introduced peroxide and thereby release radicals. For this, cobalt complexes such as cobalt octoate, which is marketed by the Akzo company under the name Accelerator NL-49P, or cobalt naphthenate are in particular used. Furthermore, cobalt-free modifications based for example on copper complexes are known.

Photoinitiators and the production thereof are for example described in “Radiation Curing in polymer Science & Technology, Vol II: Photoinitiating Systems” by J. P. Fouassier and J. F. Rabek, Elsevier Applied Science, London and New York, 1993. These are often a-hydroxyketones or derivatives thereof or phosphines. The photoinitiators, if present, can be contained in quantities from 0.2 to 10 wt. %. As photoinitiators, for example the following products obtainable on the market are possible: Basf-CGI-725 (BASF), Chivacure 300 (Chitec), Irgacure PAG 121 (BASF), Irgacure PAG 103 (BASF), Chivacure 534 (Chitec), H-Nu 470 (Spectra group limited), TPO (BASF), Irgacure 651 (BASF), Irgacure 819 (BASF), Irgacure 500 (BASF), Irgacure 127 (BASF), Irgacure 184 (BASF), Duracure 1173 (BASF).

In addition, the composition can contain up to 50 wt. %, preferably 15 to 40 wt. % of a polymer, preferably a poly(meth)acrylate or a polyester. For better differentiation, this optional polymer component is also described below as prepolymer, By addition of such polymers, the viscosity of the composition can be adjusted in the impregnation of the fibre material and in the processing of the prepregs, such as for example during moulding, Furthermore, the prepolymers are used to improve the polymerization properties, the mechanical properties, the adhesion to the support material, the viscosity adjustment, and for the optical requirements for the resins. These polymers are preferably compatible with the polymers formed from the components A, B and A′. Optionally, it is also possible that these polymers are additionally functionalized with diene and/or dienophile groups.

Said poly(meth)acrylates are in general made up of the same monomers as have already been listed with regard to the monomers in the resin system. They can be obtained by solution, emulsion, suspension, bulk or precipitation polymerization and are added to the composition as pure substance.

Concerning the contents by weight in the composition according to the invention, a weight ratio of components A and D to the components B and C or to the component C′ between 95 to 5 and 50 to 50 is preferred. Such a ratio between 90 to 10 and 75 to 25 is particularly preferred. In particular, the mole ratio of the functional groups in component B to the functional groups in component C can lie between 2 to 1 and 1 to 2. Quite especially preferably, this ratio is ca. 1 to 1.

Particularly preferably, the composition contains 30 to 80 wt. % of components A, B and optionally A′, 1 to 30 wt. % of component C, 0 to 40 wt. % of polymer and 0.5 to 8 wt. % of component D. Quite especially preferably, the composition contains 40 to 50 wt. % of the components A and optionally A′, 2 to 10 wt. % of component B, 2 to 10 wt. % of component C, 0 to 30 wt. % of polymer and 3 to 6 wt. % of component D.

In addition, still further components can optionally be contained in the composition. As auxiliary agents and additives, chain transfer agents, plasticizers, stabilizers and/or inhibitors can additionally be used. Furthermore, dyes, fillers, wetting, dispersing and levelling additives, adhesion promoters, UV stabilizers, antifoaming agents and rheology additives can be added.

As chain transfer agents, all compounds known from radical polymerization can be used. Preferably mercaptans such as n-dodecylmercaptan are used.

Thus, conventional UV stabilizers can be used. The UV stabilizers are preferably selected from the group of the benzophenone derivatives, benzotriazole derivatives, thioxanthone derivatives, piperidinolcarboxylic acid ester derivatives or cinnamic acid ester derivatives.

From the group of the stabilizers or inhibitors, substituted phenols, hydroquinone derivatives, phosphines and phosphites are preferably used.

As rheology additives, polyhydroxycarboxamides, urea derivatives, salts of unsaturated carboxylate acids, alkylammonium salts of acidic phosphoric acid derivatives, ketoximes, amine salts of p-toluene-sulphonic acid, amine salts of sulphonic acid derivative and aqueous or organic solutions or mixtures of the compounds are preferably used. It was found that rheology additives based on pyrogenic or precipitated, optionally also silanized silicic acids with a BET surface area of 10-700 nm2/g are particularly suitable.

Antifoaming agents are preferably selected from the group of the alcohols, hydrocarbons, paraffin-based mineral oils, glycol derivatives, derivatives of glycolate esters, acetate esters and polysiloxanes.

The advantage of this composition according to the invention lies in the production of a mouldable pseudo-thermoplastic semi-finished product/preprea, which in the production of the composite components, or synonymous moulded parts are reversibly melted in a further step, and thereby “decrosslinked”, but autonomously again crosslinked. Surprisingly, with the last two steps subsequent moulding of the moulded part actually already cured to the thermoset is possible.

The starting formulation is liquid and thus suitable for the impregnation of fibre material without addition of solvents. The semi-finished products are stable on storage at room temperature.

Composite semi-finished products with at least the same but also improved processing properties compared to the state of the art, which can be used for the production of effective composites for the most varied applications are thus obtained. The reactive compositions usable according to the invention are ecofriendly, inexpensive, have good mechanical properties, are simple to process and are characterized by good weather resistance and also by a balanced ratio between hardness and flexibility. In the context of this invention, the term composite semi-finished products is used synonymously with the terms prepreg and organic sheet. A prepreg is as a rule a precursor for thermosetting composite components. An organic sheet is normally a corresponding precursor for thermoplastic composite components.

As well as the composition according to the invention, a method for the production of moulded parts from this composition is equally a part of this invention. Such a process comprises the following process steps:
a) production of an above-described composition according to the invention, which contains at least the components A, B, C and D or A, C′ and D, by mixing,
b) impregnation of a fibre material with a composition from process step a),
c) curing of the composition with the impregnated fibre material by means of heat, electromagnetic radiation, electron beam and/or a plasma, and
d) optional moulding and subsequent cooling.

Here, curing under the influence of heat in process step c) takes place at temperature T₁, which to those skilled in the art follows specifically from the properties of the initiator used. As a rule, such a decomposition temperature, at which half of the initiator is available as initiator within one hour, lies between 70 and 150° C., preferably between 80 and 120° C. Particularly preferably, the initiation temperature T₁ in process step c) is higher than the retro-Diels-Aider temperature T₂ or the Diels-Alder temperature T₃ of process steps e) and g) respectively.

The fibre material or synonymous support material in the composite semi-finished product preferably used in the process according to the invention is characterized in that the fibrous supports consist for the most part of glass, carbon, plastics such as polyamide (aramid) or polyesters, natural fibres, or mineral fibre materials such as basalt fibres or ceramic fibres. The fibrous supports are present as textile fabrics of nonwoven, knitted materials, knitted or crocheted fabrics, non-knitted materials such as wovens, nonwovens or braiding, as long-fibre or short-fibre materials.

In detail, the following embodiment is present: The fibrous support in the present invention consists of fibrous material (also often referred to as reinforcing fibres). In general, any material of which the fibres consist is suitable, preferably, however, fibrous material of glass, carbon, plastics, such as for example polyamide (aramid) or polyesters, natural fibres or mineral fibre materials such as basalt fibres or ceramic fibres (oxide fibres based on aluminium oxides and/or silicon oxides) is used. Mixtures of fibre types, such as for example woven fabric combinations of aramid and glass fibres, or carbon and glass fibres, can also be used. Likewise, hybrid composites components with prepregs made from different fibrous supports can also be produced.

Mainly because of heir relatively low price, glass fibres are the most commonly used fibre types. In principle here, all types of glass-based reinforcing fibres are suitable (E-glass, S-glass, R-glass, M-glass, C-glass, ECR-glass, D-glass, AR-glass, or hollow glass fibres).

In general, carbon fibres are used in high performance composite materials, where the lower density in comparison to glass fibres with at the same time high strength is also an important factor. Carbon fibres are industrially produced fibres from carbon-containing starting materials which are converted by pyrolysis into carbon of graphite-like configuration. The distinction is made between isotropic and anisotropic types: isotropic fibres are of only low strength and low industrial importance, anisotropic fibres exhibit high strength and rigidity with at the same time low elongation at break. Here all textile fibres and fibre materials which are obtained from plant and animal material (e.g., wood, cellulose, cotton, hemp, jute, fax, sisal and bamboo fibres) are described as natural fibres. Aramide fibres, similarly also to carbon fibres, exhibit a negative coefficient of thermal expansion, i.e. become shorter on heating. Their specific strength and their modulus of elasticity are markedly lower than those of carbon fibres. In combination with the positive coefficient of expansion of the matrix resin, highly dimensionally stable components can be manufactured. Compared to carbon fibre-reinforced plastics, the compressive strength of aramide fibre composite materials is markedly lower. Well-known brand names for aramide fibres are Nomex® and Kevlar® from DuPont, or Teijinconex®, Twaron® and Technora® from Teijin. Supports made of glass fibres, carbon fibres, aramide fibres or ceramic fibres are particularly suitable and preferred. The fibrous material is a textile fabric. Textile fabrics of nonwoven material, also so-called knitted materials, such as knitted and crocheted materials, but also non-knitted fabrics such as wovens, non-wovens or braiding are suitable. In addition, a distinction is made between long-fibre and short-fibre materials as supports. Also suitable according to the invention are rovings and yams. In the context of the invention, all the said materials are suitable as fibrous supports. An overview of reinforcing fibres is contained in “Composites Technologies”, Paolo Ermanni (Version 4), Script for lecture at ETH Zurich, August 2007, Chapter 7.

In subsequent steps equally belonging to the invention, the moulded part produced by means of the process steps a) to d) can be further processed. These process steps e) to g) needed for this can be repeated multiple times for this:
e) the moulded part which was obtained from the process steps a) to d), is heated to a temperature T₂, which lies above the retro Diels-Alder temperature of the cured composition,
f) is moulded and
g) is again cooled below the retro Diels-Alder temperature T₃. During this, the crosslinking again takes place, and the moulded part again has elastomeric or, preferably, thermosetting properties.

The temperatures T₂, which must be exceeded in order to enable the retro Diels-Alder reaction, and the temperature T₃, which must be gone below in order to enable renewed crosslinking by means of a Diels-Alder reaction, also follow for those skilled in the art from the particular functional groups selected for this. Ideally, these two temperatures are almost identical,

The diene-functionalized (meth)acrylate components—when T₁ is lower than T₂ or T₃—already crosslink in the polymerization or - in the preferred case that T₁ is higher than T₂ or T₃—subsequently after cooling, with the di- or multifunctional dienophile components already present in the composition, and the reaction in the case of defined pairings can be accelerated by an increased temperature. This temperature lies below the retro Diels-Alder temperature T₂, at which the back reaction of the Diels-Alder adducts to the diene functionalities and dienophile functionalities takes place again. In this manner, below the retro Diels-Aider temperature dimensionally stable thermosets or reversibly crosslinked composite components can be created.

In particular, the diene and dienophile functionality are selected for this in such a manner that at room temperature these can undergo a Diels-Alder reaction with one another, and that the temperature T₂ for the retro Diels-Alder reaction lies in a technically easily accessible range. Ideally T₃ lies between 50 and 300° C., preferably between 80 and 200° C. and particularly preferably between 100 and 150° C.

Over and above the composition according to the invention described above, and the process for the production or the further processing of moulded parts from this composition, these moulded parts and in particular the use thereof are also part of the present invention. Such use of a moulded part according to the invention can in particular take place in the construction industry, for the production of sports goods, in automobile manufacture, in the aerospace industry, in electrical devices or installations, in wind power systems, in medical technology, in particular as orthopaedic material, or in boat and ship-building.

1: A composition, comprising components A to D:
A: a (meth)acrylate monomer with an alkyl residue with 1 to 10 carbon atoms, styrene or a mixture of the (meth)acrylate monomer and styrene,
B: a (meth)acrylate with a residue which comprises a conjugated diene,
C: a crosslinker having at least two dienophilic groups, and
D: a thermally activatable initiator, a combination of an initiator and an accelerator, a photoinitiator, or a combination thereof,
wherein the components B and C alternatively or additionally can be present as a product C′ of a Diels-Alder reaction of these two components.

2: The composition according to claim 1, wherein component B is one or more compounds of the following formulae: 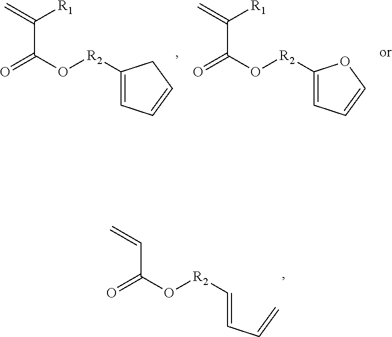
wherein
R₁ is hydrogen or a methyl group, and
R₂ is a divalent alkyl group with 1 to 4 carbon atoms.

3: The composition according to claim 1, wherein
component C is a dienophile with at least two carbon-sulphur double bonds.

4: The composition according to claim 3, wherein component C is a compound with the structure 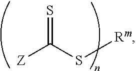
wherein
Z is an electron-withdrawing group,
R^{m} is a polyvalent organic group or a polymer, and
n is a number between 2 and 20.

5: The composition according to claim 1, wherein the compound C′ is a compound with the structure 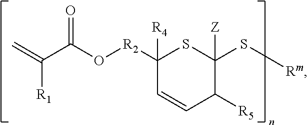
wherein
R₁ is hydrogen or a methyl group,
R₂ is a divalent alkyl group with 1 to 4 carbon atoms,
Z is an electron-withdrawing group,
R^{m} is a polyvalent organic group or a polymer,
n is a number between 2 and 20,
R₅ is an alkyl or aryl group,. and
R₄ is hydrogen
or the residues R₄ and R₅ are a bridging oxygen atom or a bridging methylidene group.

6: The composition according to claim 1, wherein the composition further comprises 15 to 40 wt. % of a polymer.

7: The composition according to claim 1, wherein
component C′ is the Diels-Alder product of a compound represented by the following formulae: 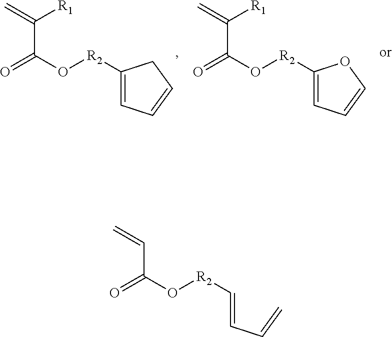
and a compound with the structure 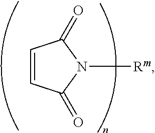
wherein
R₁ is hydrogen or a methyl group,
R₂ is a divalent alkyl group with 1 to 4 carbon atoms,
R^{m} is a polyvalent organic group or a polymer, and
n is a number between 2 and 20.

8: The composition according to claim 7, wherein the compound C′ is a compound with the structure 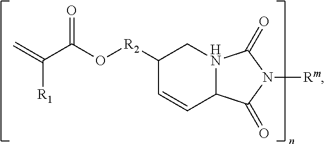
wherein R₁ is hydrogen or a methyl group,
R₂ is a divalent alkyl group with 1 to 4 carbon atoms,
Z is an electron-withdrawing group,
R^{m} is a polyvalent organic group or a polymer, and
n is a number between 2 and 20.

9: The composition according to claim 1, wherein
the weight ratio of components A and D to the components B and C or to the component C′ lies between 95 to 5 and 50 to 50.

10: The compition accordin to claim 1, wherein the composition further comprises a component A′, which is a functionalized (meth)acrylate.

11: The composition according to claim 10, wherein
the composition comprises 30 to 80 wt. % of components A, B and optionally A′, 1 to 30 wt. % of component C, 0 to 40 wt. % of polymer and 0.5 to 8 wt. % of component D.

12: The composition according to claim 10, wherein the composition comprises 40 to 50 wt. % of the components A and optionally A′, 2 to 10 wt. % of component B, 2 to 10 wt. % of component C, 0 to 30 wt. % of polymer and 3 to 6 wt. % of component D.

13: A process for the production of a moulded article, comprising:
a) mixing components A, B, C, and D to form a composition according to claim 1,
b) impregnating a fibre material with a composition from said a) mixing,
c) curing of the composition with at least one of heat, electromagnetic radiation, an electron beam, and a plasma, and
d) moulding the composition to form a moulded article and, optionally, subsequently cooling the moulded article.

14: The process according to claim 13, further comprising
e) heating the moulded article from said d) moulding to a temperature T₂, which lies above the retro Diels-Alder temperature of the cured composition,
f) moulding the composition after said e) heating, and
g) cooling the inoulded composition below the Diels-Alder temperature T₃.

15. (canceled)

16: The process according to claim 13, wherein the moulded article is an orthopaedic material.

17: The composition according to claim 1, wherein the composition further comprises 15 to 40 wt. % of a poly(meth)acrylate or a polyester.

18: The composition according to claim 1, wherein the composition further comprises a component A′, which is a glycidyl (meth)acrylate.
